(19) United States
(12) Patent Application Publication
(10) Pub. No.: US 2021/0051858 A1
(43) Pub. Date: Feb. 25, 2021

(54) SHREDDER

(71) Applicant: ELOY STRUCK, II, Bay City, MI (US)

(72) Inventor: ELOY STRUCK, II, Bay City, MI (US)

(21) Appl. No.: 16/546,471

(22) Filed: Aug. 21, 2019

(51) Int. Cl. A01G 3/00; B02C 18/24

(52) U.S. Cl. CPC A01G 3/002; B02C 2018/162; B02C 18/24

(57) ABSTRACT

A portable debris shredder for shredding lawn debris for easier stockpiling or disposal.

### BACKGROUND OF THE INVENTION

The applicant is unaware of any prior art with reference to the present invention.

### THE INVENTION

The present invention is a portable lawn debris shredder. The portable lawn debris shredder comprises a housing. The housing has a top end, a bottom, a bottom end, and at least one air hole through a wall thereof.

There is inserted in the housing an electric motor. The electric motor has electrical connectability to a battery through an electrical switch. The electrical motor has an elongated center rotatable shaft. There is a first bar support member supporting the housing. There is a second cross bar support member surmounting the first cross bar support member.

The second cross bar support member has a hub securely mounted to a bottom of the second crossbar support member with an inside surface of the hub having threads.

There is a trimmer head mounted on the centered rotatable shaft. The trimmer head contains trimmer line.

The inside surface at the top end of the housing has threads compatible with the hub of the second cross bar support member.

There is in combination, a portable lawn debris shredder with a funnel wherein the shredder is mounted inside the funnel using the first and second cross bar support members.

Some of the component parts of the portable lawn debris shredder are manufactured from plastic such as polyethylene or crosslinked polyethylene, or polypropylene or metal, such as aluminum.

### BRIEF DESCRIPTION OF THE DRAWINGS

FIG. 1 is a full side view of the portable lawn debris shredder.

FIG. 2 is a cross sectional view of the portable lawn debris shredder of FIG. 1 through line A-A.

FIG. 3 is an exploded view of the first cross bar support member, second cross bar support member, housing, motor and hub.

FIG. 4 is a full to view of the housing.

FIG. 5 is a full cross sectional side view of the housing along line B-B of FIG. 4.

FIG. 6 is a full bottom view of the housing.

FIG. 7 is a full top view of the first cross bar support member.

FIG. 8 is a full cross sectional side view of the first cross bar support member through line C-C of FIG. 7.

FIG. 9 is a full bottom view of the first cross bar support member.

FIG. 10 is a full top view of the second cross bar support member.

FIG. 11 is a full cross sectional view of the second cross bar support member fro line D-D of FIG. 10.

FIG. 12 is a full bottom view of the second cross bar support member.

FIG. 13 is an illustration of the funnel in combination with the motor and housing.

FIG. 14 is a full view in perspective of the funnel from the bottom.

### DETAILED DESCRIPTION OF THE DRAWINGS

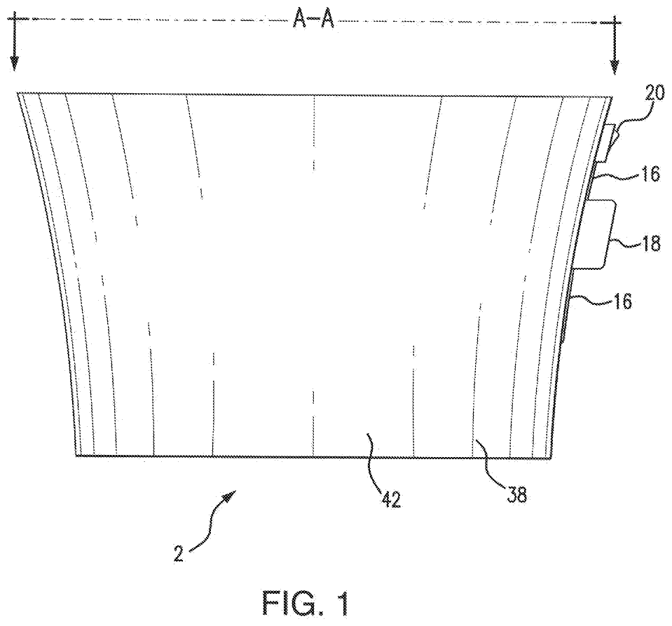

FIG. 1 shows the portable lawn debris shredder 2 from the side. The funnel 38 has an outside surface 40 that contains the battery pack 18 that powers the debris shredder 2. The electric switch 20 is also mounted to the outside surface 40 of the funnel 38.

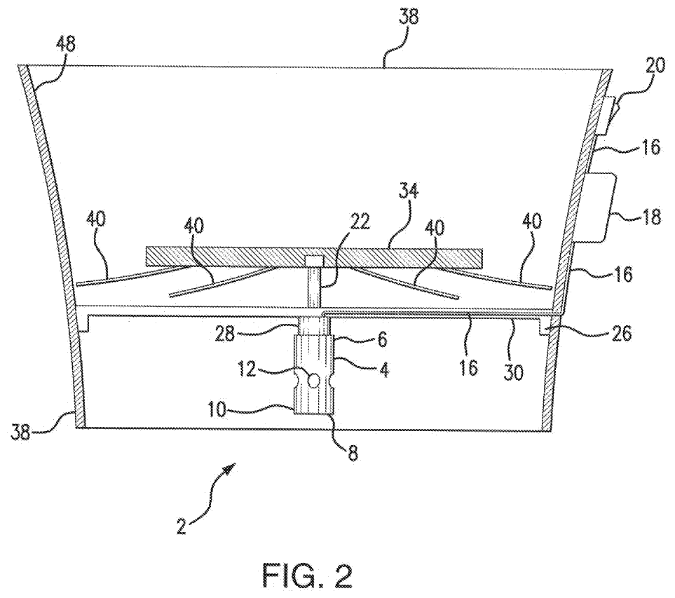

FIG. 2 shows the portable lawn debris shredder 2 along line A-A of FIG. 1. The debris shredder 2 has a housing 4. The housing 4 has a top end 6, bottom 8, a bottom end 10 and air holes 12. The housing 4 houses an electric motor 14 (not shown) that rotates the shaft 22. The electric motor has wiring 16. There is an electric switch 20 mounted to the outside surface 42 of the funnel 38. The battery pack 18 is also mounted to the outside surface 42 of the funnel 38. There is wiring 16 connecting the battery pack 18, electric switch 20 and the electric motor 14. The funnel 38 has an inside surface 48.

The electric motor 14 rotates the shaft 22 which rotates the trimmer head 34. As yard debris is dropped through the funnel 38 the rotation of the trimmer head 34 the string of the trimmer head 34 shreds the debris, then it falls into a container or bag.

The second cross bar support member 26 has a hub 28 extending from the bottom 30. This hub 28 is threaded. The housing 4 is threaded to accept the threads of the hub 28. The housing 4 has air holes to prevent over heating of the electric motor 14 in the hub 28.

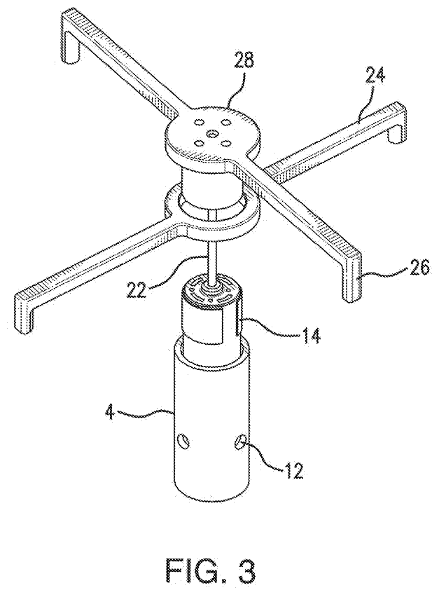

FIG. 3 shows the first cross bar support member 24, second cross bar support member 26, housing 4, electric motor 14 and hub 28. Both cross bar support members 24 and 26 are connected to the inside surface 44 of the funnel 38. The electric motor 14 is housed within the housing 4 and is supported by both cross bar support members 24 and 26. The hub 28 is threaded to accept the threads of the housing 4. The shaft 12 extends from the electric motor 14 through, and past, the hub 28 and is then connected to the trimmer head 34.

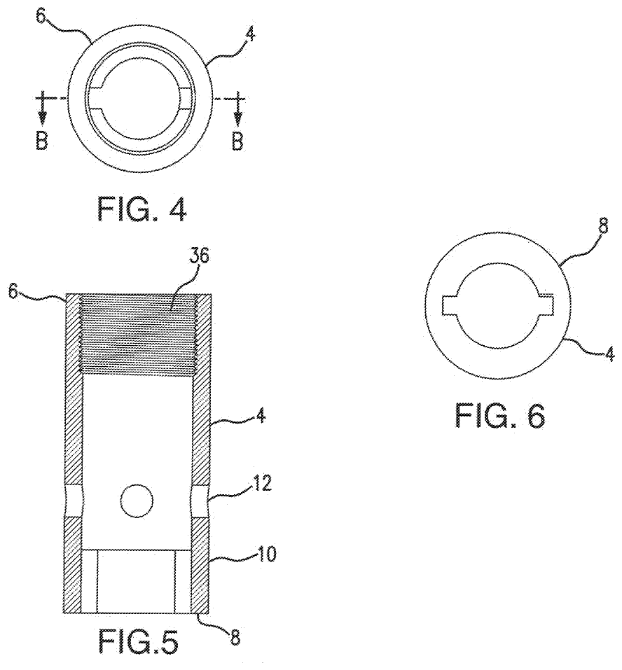

FIG. 4 shows the housing 4 from the top 6 with line B-B. FIG. 5 shows the housing 4 along line B-B. The housing 4 has a top 6 and a bottom 8. The housing 4 has a bottom end 10, air holes 12 and threads 36. FIG. 6 shows the housing 4 from the bottom 8.

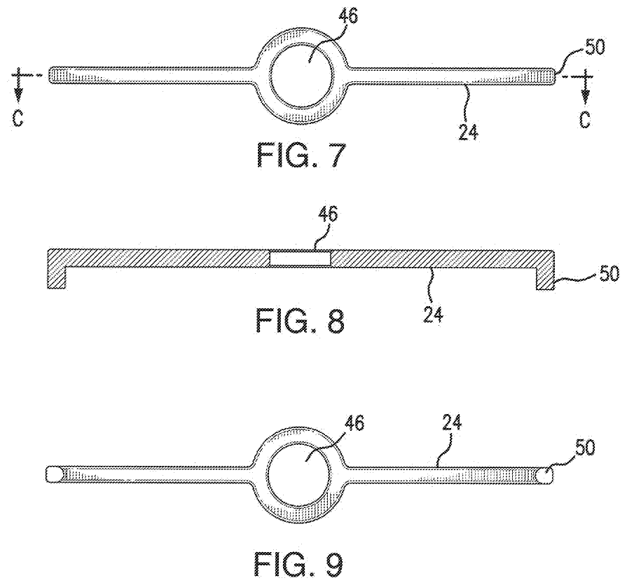

FIG. 7 shows the first cross bar support member 24 from the top with line C-C. The first cross bar support member 24 has an opening therethrough which allows the hub 28 to pass through. Each end 50 of the first cross bar support 24 is connected to the inside edge 48 of the funnel 38.

FIG. 8 shows the first cross bar support member 24 from the side along line C-C. Again, the first cross bar support member 24 has an opening 46 therethrough. Each end 50 of the first support cross bar member 24 is connected to the inside surface 48 of the funnel 38.

FIG. 9 shows the first cross bar support member 24 from the bottom. Again, the first cross bar support member 24 has an opening therethrough 46. Each end 50 of the first support cross bar member 24 is connected to the inside surface 48 of the funnel 38.

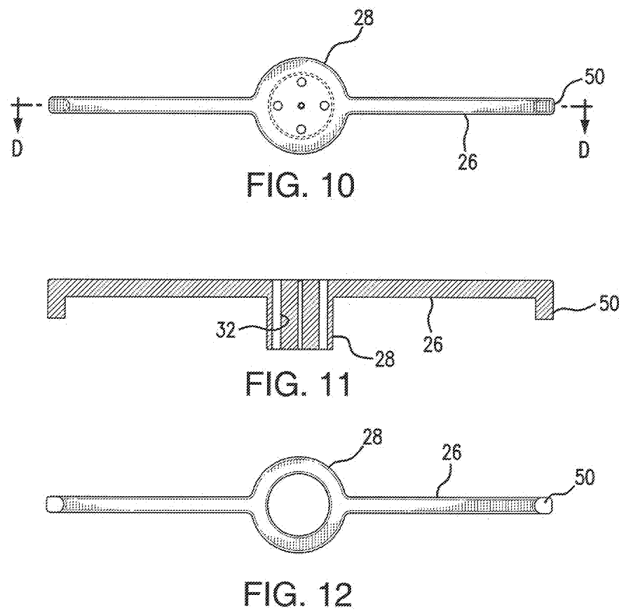

FIG. 10 shows the second cross bar support member 26 from the top with line D-D. The second cross bar support member 26 has a hub 28 near its center. Each end 50 of the second cross bar support member is connected to the inside surface 48 of the funnel 38.

FIG. 11 shows the second cross bar support member from the side along line D-D. The second cross bar support member 26 has the hub 28 near its center. Each end 50 of the second cross bar support member is connected to the inside surface 48 of the funnel 38. The hub contains threads 32 that are accepted by the threads 36 of the housing 4.

FIG. 12 shows the second cross bar support member 26 from the bottom. Again, the second cross bar support member 26 has the hub 28 near its center. Each end 50 of the second cross bar support member is connected to the inside surface 48 of the funnel 38.

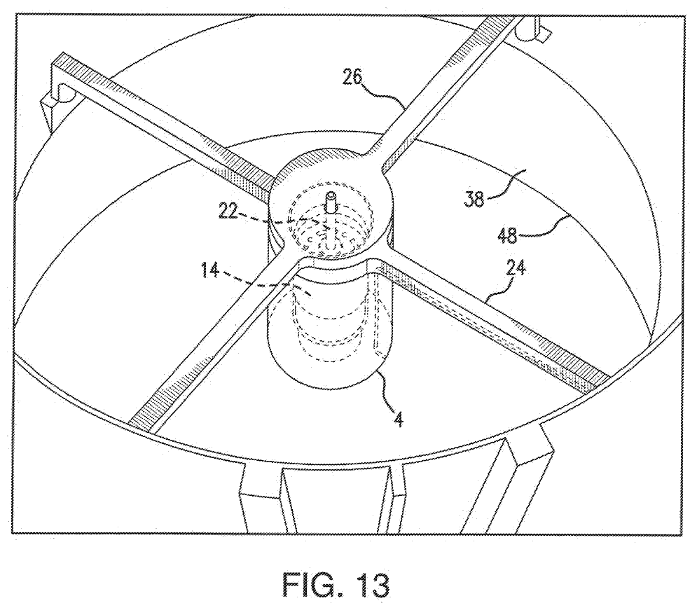

FIG. 13 show the funnel 38 with the motor 14 and housing 4. This shows the electric motor 14 within the housing 4. The first and second cross bar support members 24 and 26 are connected to the inside surface 48 of the funnel 38.

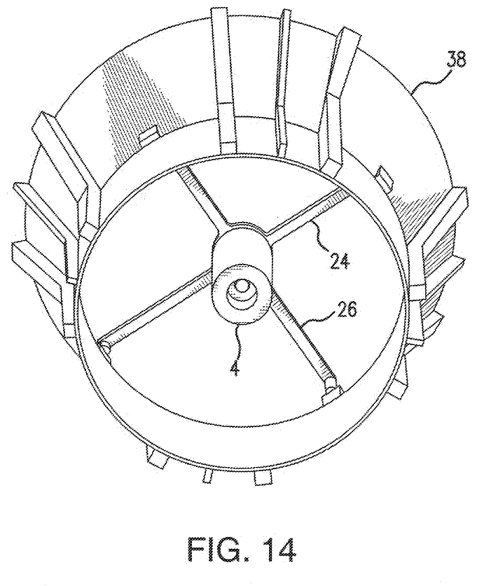

FIG. 14 shows the funnel 38 from the bottom. This figure shows the 14 relationship between the first and second cross members 24 and 26, and the electric motor.

It has been discovered that the portable debris shredder is a lightweight portable device that is capable of being moved around a yard to reduce debris for composting or disposal. The battery powered device is placed in an area then the debris is gathered and run through the funnel with the trimmer head rotating, reducing the size of the debris for easier disposal.

What is claimed is:

1. A portable debris shredder, said portable debris shredder comprising in combination:
I. a housing, said housing having a top end, a bottom, a bottom end, and at least one air hole through a wall thereof;
II. inserted in said housing, an electric motor, said electric motor having electrical connectability to a battery through an electrical switch, said electrical motor having an elongated center rotatable shaft;
III. a first cross bar support member supporting said housing;
IV. a second cross bar support member surmounting said first cross bar support member;
V. said second cross bar support member having a hub securely mounted to a bottom of said second crossbar support member, an inside surface of said hub having threads;
VI. a trimmer head mounted on said centered rotatable shaft, said trimmer head containing trimmer line;
VII. the inside surface at said top end of said housing having threads compatible with said hub of said second cross bar support member.

2. In combination, a portable lawn debris shredder as claimed in claim 1 and a funnel wherein said shredder is mounted inside said funnel using said first and second cross bar support members.

3. The portable lawn debris shredder as claimed in claim 1 wherein some of the component parts are manufactured from plastic.

4. The portable lawn debris shredder as claimed in claim 3 wherein the plastic is polyethylene.

5. The portable lawn debris shredder as claimed in claim 3 wherein the plastic is polypropylene.

6. The portable lawn debris shredder as claimed in claim 3 wherein the plastic is crosslinked polyethylene.

7. The portable lawn debris shredder as claimed in claim 3 wherein some of the component parts are manufactured from metal.

8. The portable lawn debris shredder as claimed in claim 8 wherein the metal is aluminum.
